(19) United States
(12) Patent Application Publication
(10) Pub. No.: US 2022/0365524 A1
(43) Pub. Date: Nov. 17, 2022

(54) DEVICE FOR FAULT DETECTION AND FAILURE PREDICTION BY MONITORING VIBRATIONS OF OBJECTS IN PARTICULAR INDUSTRIAL ASSETS

(71) Applicants: Marc Jean Baptist Van Oldenborgh, Amsterdam (NL); Ernst Peter Hovinga, Bloemendaal (NL)

(72) Inventors: Marc Jean Baptist Van Oldenborgh, Amsterdam (NL); Ernst Peter Hovinga, Bloemendaal (NL)

(21) Appl. No.: 17/319,215

(22) Filed: May 13, 2021

(51) Int. Cl. G05B 23/02; G05B 19/418; G06N 20/00

(52) U.S. Cl. CPC G05B 23/0283; G05B 23/0289; G05B 19/4183; G05B 19/4184; G06N 20/00

(57) ABSTRACT

A device configured to monitor a vibrating object, the device comprising a common housing holding an accelerometer for sampling vibration signatures of the vibrating object, resulting in vibration samples, and a computing device comprising a data processor and a memory having stored thereon a computer program product for monitoring the vibrating object, the computer program product comprising an input module to receive the vibration samples, an analysis module to analyze the vibration samples to derive asset health scores, a machine learning model to determine asset operating ranges, and an output module to output messages, wherein the computer program product when running on the data processor causes the computing device to receive during a time interval, having an end time t1, the vibration samples from the accelerometer, resulting in a time series vector array, and to analyze the vibration samples comprising deriving from the time series vector array a baseline asset health score and deriving from the time series vector array a time series asset health score, and to subject at least a part of the time series asset health score to the machine learning model for determining at least one asset operating range, and to receive a further vibration sample at a monitor time t2 wherein the monitor time t2 is subsequent to the end time t1, and to derive from the further vibration sample an asset health score, and to determine if the asset health score falls within an operating range determined by the machine learning model, resulting in a monitor result, and to output a message depending on the monitor result, and wherein the device consumes less current than 20 mA.

### TECHNICAL FIELD

The current invention relates to a device, a system, a method and a computer program product for monitoring vibrations of devices (in particular rotary devices), pipelines and other vibrating objects.

### BACKGROUND

As industrial operations become more and more complex, today's plants and other manufacturing and processing facilities contain more and more machines and other complex mechanical components and devices of all sizes and shapes and for an exceedingly large variety of applications.

These machines may include compressors, turbines, pumps, motors, fans and other devices that employ some manner of rotation in connection with their operation.

Often these machines need monitoring in order to confirm their (critical) operation, to schedule maintenance, to detect failure and to prevent failure.

Likewise, constructions such as buildings and other constructions (bridges, cranes, lifts, etc.) need monitoring.

Likewise, vehicles (cars, trucks, boats, plane, etc.) and satellites need monitoring.

Unscheduled downtime due to failures often represent a significant cost burden to the end-user of industrial assets and equipment, constructions, vehicles and satellites.

In “IoT connected device for vibration analysis and measurement”, April 2020, by Ivar Koene et al. (https://arxiv.org/abs/xxx) according to its abstract describes “Accelerometers are widely used in applications, such as condition measurement, motion tracking, and vehicle monitoring. Most handheld smart devices, such as smart phones and tablets, employ accelerometers for motion tracking. The size constraints of such devices has provided the impetus to develop precise, affordable, compact, and power-efficient accelerometers. Microelectromechanical systems (MEMS) accelerometers meet these strict requirements, thus explaining their wide adoption in the smart device market. The increasing cost-performance ratio, particularly regarding accuracy and bandwidth, of modern MEMS accelerometers enables their use in demanding measurement applications. This research introduces an open source battery-powered Internet of Things MEMS accelerometer called Memsio. Memsio is a versatile wireless sensor unit that can be deployed to measure a wide range of different motions. It is operated from a web browser, thus rendering it remotely accessible via smart phone, tablet, or computer. Furthermore, Memsio offers high-speed motion data acquisition capabilities and can store extended measurement periods lasting dozens of minutes; in addition, its wireless and portable nature eases integration in condition monitoring applications. The study presented reports on the construction and functionality of Memsio. Additionally, the functionality of Memsio is demonstrated in the measurement of translational movement of a linear actuator and the vibrations of large rotating machinery.”

In “Review of Vibration-Based Structural Health Monitoring Using Deep Learning”, January 2020, by Gyungmin Toh et al. (https://www.mdpi.com/2076-3417/10/5/1680/htm) according to its abstract describes “With the rapid progress in the deep learning technology, it is being used for vibration-based structural health monitoring. When the vibration is used for extracting features for system diagnosis, it is important to correlate the measured signal to the current status of the structure. The measured vibration responses show large deviation in spectral and transient characteristics for systems to be monitored. Consequently, the diagnosis using vibration requires complete understanding of the extracted features to discard the influence of surrounding environments or unnecessary variations. The deep-learning-based algorithms are expected to find increasing application in these complex problems due to their flexibility and robustness. This review provides a summary of studies applying machine learning algorithms for fault monitoring. The vibration factors were used to categorize the studies. A brief interpretation of deep neural networks is provided to guide further applications in the structural vibration analysis.”

U.S. patent application Ser. No. 16/515,564 according to its abstract describes: “A system for estimating a severity of a bearing fault in an induction motor, uses a set of filters and a set of quantitative models designed for a set of fault frequencies. The system, upon receiving the measurements of the stator current, extracts the first fault current from the stator current using the first filter, determine the first mutual inductance variation from the first fault current using the first quantitative model, and classify the first mutual inductance variation with the fault severity classifier to determine the severity of a first type of fault in the induction motor. Similarly, the system classifies a second type of fault using the second filter and the second quantitative model. The system outputs one or combination of the severity of the first type of fault in the induction motor and the severity of the second type of fault in the induction motor.”

In “Developing a smart and low cost device for machining vibration analysis”, July 2018, by Pierrick Rauby (http://hdl.handle.net/1853/60296) according to its abstract describes “Internet of Thing (IoT) is receiving an enormous attention especially when it comes to monitor machining operations. However, current technology must continue to evolve in order to reduce cost and to improve data analytics1. More importantly, IoT devices often raise security concerns, as they transfer a considerable amount of data to the cloud. Simultaneously, the computational power of embedded platforms has increased, giving the ability to process data locally; thus, edge computing is able to reduce the security problem as they minimize the quantity of information transferred to the cloud. Therefore, these problems can be addressed by developing a truly smart low-cost device that takes advantage of fog computing as opposed to cloud computing. Frameworks have been developed to demonstrate the capability to remotely monitor machine health using cloud computing, the objective of this thesis is to associate those frameworks to the computational power of low-cost embedded platforms to process data locally and in real-time. For this work a BeagleBone Black is used. It is powered by an AM335x ARM Cortex-A8 processor that runs at 1 GHz. This computer is associated with an analog accelerometer through its Analog to Digital Converter. The system is monitoring vibrations on a bandsaw, as it is running Linux it does not have deterministic-sampling capabilities; therefore, the Industrial I/O subsystem is used to enable hardware interrupts on the Linux Kernel space. The vibrations generated by the cutting of different materials are recorded and used to train a machine learning algorithm on an external computer. Training will use a Kernel Support Vector Machine algorithm. Once the algorithms are trained they are will be implemented locally on the BeagleBone Black so that the analytics of the data are done at the “edge”. The final goal is to be able to determine the nature of the material that is being cut by the bandsaw.”

In “Remote Condition Monitoring of Elevator's Vibration and Acoustics Parameters for Optimised Maintenance Using IoT Technology”, May 2018, by Isaac Opeyemi Olalere et al. (https://www.researchgate.net/publication/327326544) according to its abstract describes “Remote Condition Monitoring (RCM) of machines deploys condition monitoring of machine conditions with reduced manning to enhance proactive maintenance. Vibration and acoustics parameter of the machine helps in diagnosing the condition of the machine for early detection of faults in the system. This paper employs a Remote Condition Monitoring approach of two elevator parameters, vibration and acoustics, using an Internet of Things (IoT) device for Remote Data Acquisition (RDA) and Remote Fault Indication (RFI). A remote monitoring set-up was developed comprising of augmented sensors networked connections and Arduino Yun microcontroller, installed on the elevator system to remotely monitor the deterioration in the working condition. The set-up was configured to monitor the conditions online, through email application service. The data from the email were analyzed and notifications generated at the severity level of each parameter. The result showed that, vibration and acoustics parameters are complimentary in fault diagnosis, and that RCM enables faster repair and maintenance decision and prevent the catastrophic breakdown of the machine.”

In “Vibration Signature Analysis and Parameter Extractions on Damages in Gears and Rolling Element Bearings”, September 2011, by Chia-Hsuan Shen et al. (https://www.hindawi.com/journals/isrn/2011/402928) according to its abstract describes “This paper is to analyze and identify damage in gear teeth and rolling element bearings by establishing pattern feature parameters from vibration signatures. In the present work, different damage scenarios involving different combinations of gear tooth damage, bearing damage are considered. Each of the damage scenarios are studied and compared in the time domain, the frequency domain, and the joint time-frequency domain using the FMO technique, the Fourier Transform, the Wigner-Ville Transform, and the Continuous Wavelet Transform, respectively. Results obtained from the three different signal domains are analyzed to develop indicative parameters and visual presentations that measure the integrity and wellness of the bearing and gear components. The joint time-frequency domain obtained from the continuous wavelet transform has shown to be a superior technique for providing clear visual examination solution for different types of component damages as well as for feature extractions used for computer-based machine health monitoring solution.”

In “Computational Intelligence for Condition Monitoring”, May 2007, by Tshilidzi Marwala et al. (https://arxiv.org/abs/0705.2604) according to its abstract describes “Condition monitoring techniques are described in this chapter. Two aspects of condition monitoring process are considered: (1) feature extraction; and (2) condition classification. Feature extraction methods described and implemented are fractals, Kurtosis and Mel-frequency Cepstral Coefficients. Classification methods described and implemented are support vector machines (SVM), hidden Markov models (HMM), Gaussian mixture models (GMM) and extension neural networks (ENN). The effectiveness of these features were tested using SVM, HMM, GMM and ENN on condition monitoring of bearings and are found to give good results.”

U.S. Pat. No. 4,520,674 according to its abstract describes: “A portable vibration monitoring device (10) for use in connection with a base computer (11) which stores data regarding the nature and parameters of vibration measurements to be made on preselected machines for predictive maintenance purposes. The device includes a power module (36) which energizes the various components. A vibration sensor (14) produces an analog signal which is representative of selected vibration parameters. The signal generated by the vibration monitor is conditioned by a signal conditioning module (16) which includes anti-aliasing filters which enhance the accuracy of the data collected. A multiple function module (18) includes various selectively energized modules which enhance the speed and reliability of the data collected. This data is analyzed by a microprocessor and displayed as desired.”

### SUMMARY

A system and methodology for continuous condition monitoring and fault mode detection of rotating equipment employ adaptive anomaly detection techniques to determine the overall condition, vibration spectrum and fault mode diagnostics of a rotating machine from the time-based vibration data gathered by an edge computing device. Asset condition is determined based upon the input of a digitized time-based sample sequence of vibration data acquired directly from an edge computing device with an embedded accelerometer for on-line real-time measurement of the machine condition. Once asset condition is determined, edge computing device's embedded microcontroller-based vibration analysis for a given vibration signature may be performed. The present invention extracts characteristic vibration features from vibration data and uses these extracted values to provide condition detection and diagnoses of machine faults.

Techniques are described for condition monitoring of industrial assets and equipment and fault prediction using edge computing devices. According to embodiments described herein one or more edge computing devices utilize sensors to collect, process and analyze asset performance data. The sensor data identifies a condition associated with at least one asset operating mode. The one or more edge computing devices determine, from the sensor data, a correlation between the operating condition of a particular asset or equipment and a set of one or more predetermined fault conditions that are associated with a similar class of assets or equipment. The one or more edge computing device generate, based, at least in part, on the correlation, a prediction of a quality of asset or equipment performance.

A system for industrial asset monitoring implemented on a battery-operated edge computing platform includes a data collection function that acquires time series values of selected variables for one or more of the components of an industrial asset or equipment, a pre-processing function that calculates specified characteristics of the time series values, a machine learning analysis function for evaluating the characteristics to produce one or more hypotheses of a condition of the one or more components, and a reasoning function for determining the condition of the one or more components from the one or more hypotheses.

In order to maintain, troubleshoot and otherwise operate machines over time, it is often important to obtain relatively frequent vibration readings with respect to the rotational elements of the machines. These readings can be used to diagnose many problems with the machines that are not readily apparent to the naked eye or are otherwise difficult or impossible to ascertain without the aid of the vibration readings. For example, significant deviations in vibration from that which is called for in the machine specification may indicate the existence of an operational problem.

Also, significant deviation from the past characteristic operating vibration for a particular machine may signal that some form of maintenance or repair is required. As yet another example, known operational problems may be suspected based upon vibration information as the vibration frequency spectrum of the machine relates to the rotational speed of the machine. The presence of excessive vibration levels at certain frequencies, known as defect or fault frequencies, usually indicates a specific machine fault or operational problem.

In order to properly make such diagnoses, it is quite important for the vibration readings to be accurate, because improper or inaccurate vibration readings can lead to the false belief that a problem exists when one actually does not or, alternatively, the false belief that a problem does not exist when, in fact, one actually does. Additionally, inaccurate vibration readings can lead to misdiagnosis of a machine problem. High accuracy of vibration readings is particularly important when high frequency vibration components are used to detect problems associated with rotating elements of bearings because a small error in vibration readings will be amplified at high frequencies.

In contrast to prior art techniques for estimating vibration and performing condition monitoring, the present invention processes the vibration signal in edge processing devices, which utilizes vibration analysis techniques in compute resource constrained microcontrollers. This technique significantly reduces the data required to perform such analysis, greatly improves the latency of the vibration estimation, significantly increases the field of installation of devices and, as a result, better condition analysis through ubiquitous sensing.

Real time monitoring of remote industrial assets and equipment involves the administration of systems and processes for the tracking of the performance of the assets by monitoring their vibration signature. Operations and maintenance teams within the industrial sector are increasingly challenged to assure asset visibility and availability in remote locations due to the challenges involved in providing power and communications infrastructure. Various factors such as wear and tear, operator behavior and operating conditions may significantly impact and degrade the asset condition if the operations and maintenance staff are not appropriately equipped to predict, avoid, and/or react to changing and potentially hazardous conditions in remote locations.

Certain industries face unique types of constraints that may pose peculiar challenges for maintenance of remote assets. For example, a remote water pump station needs to operate in optimum conditions in order for the water utility to provide essential services to the public. The water utility responsible for managing the water infrastructure may be required to ensure that the remote pumps are operating properly. A damaged pump can prove to be catastrophic for a water utility. Due to the large number of possible scenarios, ensuring a certain quality of service can be a difficult and complex task.

A present disclosure generally relates to techniques in the field of asset condition prediction and optimization. The disclosure relates more specifically to edge computing-implemented techniques for predictive estimation of quality, performance and condition of assets across industrial implementations using condition monitoring and predictive analytics.

A number of condition monitoring methods have been developed for industrial applications. The existing systems typically implement fault detection to indicate that something is wrong in the monitored system, fault isolation to determine the exact location of the fault, i.e., the component which is faulty, and fault identification to determine the magnitude of the fault.

Many existing systems use mathematical models developed using data derived through the utilization of special sensors, pre-determined thresholds, spectrum analysis and machine learning. Such systems are generally implemented on large compute servers with considerable storage.

In such systems, equipment measurements such as vibration signatures are compared by compute servers to preset limits. Exceeding the threshold indicates a fault situation. In many systems, spectrum analysis of vibration measurements may also be used for fault detection and isolation. Most asset variables exhibit a typical frequency spectrum under normal operating conditions; any deviation from this may be an indication of abnormality. Certain types of faults may even have their characteristic signature in the spectrum, facilitating fault isolation.

Machine learning techniques form a broad class which are complementary to the methods outlined above in that they are aimed at evaluating the symptoms obtained by detection hardware and software. These machine learning model-based condition-monitoring and fault-diagnostic methods generally rely on the concept of analytical redundancy. Such computations use present and/or previous measurements of other variables, and a mathematical model describing their nominal relationship to the measured variable.

The methods described above have been primarily applied to systems that are defined by proximity to or access to large storage infrastructure, network availability and compute resources. There are, however, a class of industrial assets and equipment that cannot take advantage of the methods described above. Specifically, industrial assets and equipment in remote locations without access to network access, uninterrupted power supply, external storage infrastructure and compute resources cannot benefit from the methods described above.

It would be advantageous to provide a distributed system for monitoring conditions of and diagnosing faults in remote industrial assets and equipment by implementing the methods described above in microcontroller-based edge computing devices.

A disadvantage of prior art is that inferencing of vibration data is often executed at a remote server and requires a transmission of significantly more data in comparison to the current invention. Using a remote server (for instance in a cloud environment) for inferencing will, in many cases, be more expensive due to transmission costs and processing/cloud costs. By processing data on a local edge device, the current invention effectively compresses the data stream and allows the local edge device to operate on narrowband wireless networks, which is a significant advantage over existing solutions (which rely on broadband wireless networks). Examples of networks that the current invention can be compatible with on broadband are WiFi and LTE/4G/3G/2G, and on narrowband are Narrowband IoT (NB-IoT), LTE Cat-M1, Bluetooth, Zigbee, LoRa and Sigfox.

When prior art discloses a form of inferencing on a local edge device for monitoring a nearby object, then this edge device needs to be calibrated by a user and the device lacks a capacity of self-calibration. When prior art discloses the use of machine learning algorithms these algorithms don't meet the requirement to be executed on a low-power microcontroller that would allow a local edge device to monitor an object for months or even years on a battery (pack) with a capacity less than 20,000 mAh.

Hence, it is an aspect of the current invention to provide an improved and/or alternative device, system, method and computer program product, which preferably further at least partly obviates one or more of above-described drawbacks.

There is currently provided a device configured to monitor a vibrating object, the device comprising a common housing holding:
an accelerometer for sampling vibration signatures of the vibrating object, resulting in vibration samples, and
a computing device comprising a data processor and a memory having stored thereon a computer program product for monitoring the vibrating object, the computer program product comprising:
   an input module to receive the vibration samples;
   an analysis module to analyze the vibration samples to derive asset health scores;
   a machine learning model to determine asset operating ranges, and
   an output module to output messages,
      wherein the computer program product when running on the data processor causes the computing device to:
receive during a time interval, having an end time t1, the vibration samples from the accelerometer, resulting in a time series vector array;
analyze the vibration samples comprising:
   deriving from the time series vector array a baseline asset health score, and
   deriving from the time series vector array a time series asset health score;
subject at least a part of the time series asset health score to the machine learning model for determining at least one asset operating range;
receive a further vibration sample at a monitor time t2 wherein the monitor time t2 is subsequent to the end time t1;
derive from the further vibration sample an asset health score;
determine if the asset health score falls within an operating range determined by the machine learning model, resulting in a monitor result;
output a message depending on the monitor result, and
   wherein the device consumes less current than 20 mA.

An accelerometer is an instrument for detecting and measuring acceleration, tilt and vibration. To sense motion in multiple directions, an accelerometer must be designed with multi-axis sensors or multiple linear axis sensors. Three linear accelerometers are adequate to measure movement in three dimensions. Microelectromechanical systems (MEMS) accelerometers can be applied in the current invention. In particular any MEMS accelerometer with a sampling frequency of at least 800 Hz.

A vibration signature of an object is the characteristic pattern of vibration it generates while it is vibrating. A vibration signature can be represented by an analog signal or digital signal. For example, vibrating of a machine occurs when the machine is in operation, or vibrating of a bridge occurs when traffic is crossing the bridge. An actual signal from a vibration transducer can be considered a signature, but also the spectrum of a vibration signal is often referred to as a signature. Effective vibration analysis starts with obtaining an accurate signal from standard vibration transducer with the help of an accelerometer. The analog signal is then converted in to digital signal using analog to digital converter.

A data processor could be a microprocessor or a microcontroller, and are often simply referred to as processor. A processor may have integrated memory. Preferable, a processor that is power efficient should be applied in the current invention, especially in combination with battery power supply in order to support long lasting uninterrupted operations. Examples of processors that the current invention can be based on are: ARM 32-bit processors (Cortex M series) offered by several vendors like ST, NXP, Microchip and Infineon, Microchip AVR 8-bit microcontrollers, Microchip AVR 32-bit microcontrollers, Microchip PIC 8-bit microcontrollers.

A message can correspond to a text message or a code message (such as status or error code).

An asset health score is an indicator value of the health or condition of a vibrating object.

There is further provided a system configured to monitor a vibrating object, comprising:
a power source;
a power management circuit to control flow and direction of electrical power from the power source;
an accelerometer for sampling vibration signatures of the vibrating object, resulting in vibration samples;
a RF module;
an antenna, and
a computing device comprising a data processor and a memory having stored thereon a computer program product for monitoring the vibrating object, the computer program product comprising:
   an input module to receive the vibration samples;
   an analysis module to analyze the vibration samples to derive asset health scores;
   a machine learning model to determine asset operating ranges, and
   an output module to output messages,
      wherein the computer program product when running on the data processor causes the computing device to:
receive during a time interval, having an end time t1, the vibration samples from the accelerometer, resulting in a time series vector array;
analyze the vibration samples comprising:
   deriving from the time series vector array a baseline asset health score, and
   deriving from the time series vector array a time series asset health score;
subject at least a part of the time series asset health score to the machine learning model for determining at least one asset operating range;
receive a further vibration sample at a monitor time t2 wherein the monitor time t2 is subsequent to the end time t1;
derive from the further vibration sample an asset health score;
determine if the asset health score falls within an operating range determined by the machine learning model, resulting in a monitor result;
output a message to the RF module depending on the monitor result, and
   wherein the RF module uses the antenna to transmit the message, and
   wherein the system consumes less current than 1 A.

In an embodiment of the system, the computer program product furthermore comprises a further machine learning model to predict future asset health scores, and wherein the computer program product when running on the data processor causes the computing device to:
subject at least a part of the time series asset health score to the further machine learning model for predicting a future asset health score at a future time t4 subsequent to the end time t1;
derive, at a predict time t3, the future asset health score from the further machine learning model wherein the predict time t3 is equal or subsequent to the end time t1 and wherein the predict time t3 is prior to the future time t4;
output a message to the RF module depending on a deviation of the future asset health score from the baseline asset health score.

There is further provided a method for monitoring a vibrating object with a system consuming less current than 150 μA in standby mode and consuming less current than 20 mA in active mode, comprising:
waking up the system at a pre-determined event from the standby mode to the active mode, and
   while the system is in the active mode:
receiving during a time interval, having an end time t1, vibration samples corresponding to the vibrating object, resulting in a time series vector array;
analyzing the vibration samples comprising:
   deriving from the time series vector array a baseline asset health score, and
   deriving from the time series vector array a time series asset health score;
subjecting at least a part of the time series asset health score to a machine learning model for predicting a future asset health score at a future time t4 subsequent to the end time t1;
deriving, at a predict time t3, the future asset health score from the machine learning model wherein the predict time t3 is equal or subsequent to the end time t1, and wherein the predict time t3 is prior to the future time t4, and
outputting a message depending on a deviation of the future asset health score from the baseline asset health score.

The pre-determined event may be a pre-determined interval. Pre-determined events are for example: a vibration above a certain energy level, a temperature level above/below a number of degrees Fahrenheit, or any other sensor measurement reaching a threshold. A pre-determined event caused by a pre-determined interval can result from a timer/clock setting.

In particularly the duration of the time interval in the method is longer than the duration of a period between the predict time t3 and the future time t4.

There is further provided an extension of the method for monitoring a vibrating object, comprising furthermore while the system is in the active mode:
subjecting at least a part of the time series asset health score to a further machine learning model for determining at least one asset operating range;
receiving a further vibration sample at a monitor time t2 wherein the monitor time t2 is subsequent to the end time t1;
deriving from the further vibration sample an asset health score;
determining if the asset health score falls within an operating range determined by the further machine learning model, resulting in a monitor result, and
outputting a message depending on the monitor result.

A system (or device) in standby mode is using less energy than a system in active mode, and the system is not (fully) functional.

A system (or device) in active mode is fully functional and therefore is using more energy than a system in standby mode.

There is further provided a non-transitory computer readable medium having stored thereon computer program instructions for monitoring a vibrating object that, when executed by a processor in a computing device consuming less current than 10 mA, configure the computing device to perform:
receiving during a time interval, having an end time t1, vibration samples corresponding to the vibrating object, resulting in a time series vector array;
analyzing the vibration samples comprising:
   deriving from the time series vector array a baseline asset health score, and
   deriving from the time series vector array a time series asset health score;
subjecting at least a part of the time series asset health score to a machine learning model for predicting a future asset health score at a future time t4 subsequent to the end time t1;
deriving, at a predict time t3, the future asset health score from the machine learning model wherein the predict time t3 is equal or subsequent to the end time t1 and wherein the predict time t3 is prior to the future time t4, and
outputting a message depending on a deviation of the future asset health score from the baseline asset health score.

There is further provided an extension of the non-transitory computer readable medium having stored thereon computer program instructions for monitoring a vibrating object that furthermore configure the computing device to perform:
subjecting at least a part of the time series asset health score to a further machine learning model for determining at least one asset operating range;
receiving a further vibration sample at a monitor time t2 wherein the monitor time t2 is subsequent to the end time t1;
deriving from the further vibration sample an asset health score;
determining if the asset health score falls within an operating range determined by the further machine learning model, resulting in a monitor result, and
outputting a message depending on the monitor result.

The term “statistically” when used herein, relates to dealing with the collection, analysis, interpretation, presentation, and organization of data. In particular, it comprises modelling behavior of a population. Using probability distributions, a probability of optimizing transmission reliability is calculated and predicted.

The term “substantially”, such as in “substantially all emission” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”.

The term “functionally” will be understood by, and be clear to, a person skilled in the art. The term “substantially” as well as “functionally” may also include embodiments with “entirely”, “completely”, “all”, etc. Hence, in embodiments the adjective functionally may also be removed. When used, for instance in “functionally parallel”, a skilled person will understand that the adjective “functionally” includes the term substantially as explained above. Functionally in particular is to be understood to include a configuration of features that allows these features to function as if the adjective “functionally” was not present. The term “functionally” is intended to cover variations in the feature to which it refers, and which variations are such that in the functional use of the feature, possibly in combination with other features it relates to in the current invention, that combination of features is able to operate or function. For instance, if an antenna is functionally coupled or functionally connected to a communication device, received electromagnetic signals that are receives by the antenna can be used by the communication device. The word “functionally” as for instance used in “functionally parallel” is used to cover exactly parallel, but also the embodiments that are covered by the word “substantially” explained above. For instance, “functionally parallel” relates to embodiments that in operation function as if the parts are for instance parallel. This covers embodiments for which it is clear to a skilled person that it operates within its intended field of use as if it were parallel.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the current invention described herein are capable of operation in other sequences than described or illustrated herein.

The devices or apparatus herein are amongst others described during operation. As will be clear to the person skilled in the art, the current invention is not limited to methods of operation or devices in operation.

It should be noted that the above-mentioned embodiments illustrate rather than limit the current invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

The current invention further applies to an apparatus or device comprising one or more of the characterizing features described in the description and/or shown in the attached drawings. The current invention further pertains to a method or process comprising one or more of the characterizing features described in the description and/or shown in the attached drawings.

The various aspects discussed in this patent can be combined in order to provide additional advantages. Furthermore, some of the features can form the basis for one or more divisional applications.

### DRAWINGS

Embodiments of the current invention will now be described, by way of example only, with reference to the accompanying schematic drawings (which are not necessarily drawn to scale) in which corresponding reference symbols indicate corresponding parts, and in which:

FIG. 1A and FIG. 1B schematically depict a simplified diagram of an embodiment of a device configured to monitor a vibrating object.

FIG. 2 schematically depicts an embodiment of a device monitoring a wind turbine.

FIG. 3 schematically depicts a simplified diagram of an embodiment of a system configured to monitor a vibrating object.

FIG. 4 schematically depicts an embodiment of a system monitoring an engine with a connecting to a cloud server.

FIG. 5 schematically depicts a vibration spectrum analysis of a complex vibration over time in three frequency bands.

FIG. 6 depict a simplified flow chart of an example firmware stack.

FIG. 7A and FIG. 7B depict a simplified block diagram of a computer program product.

### DESCRIPTION

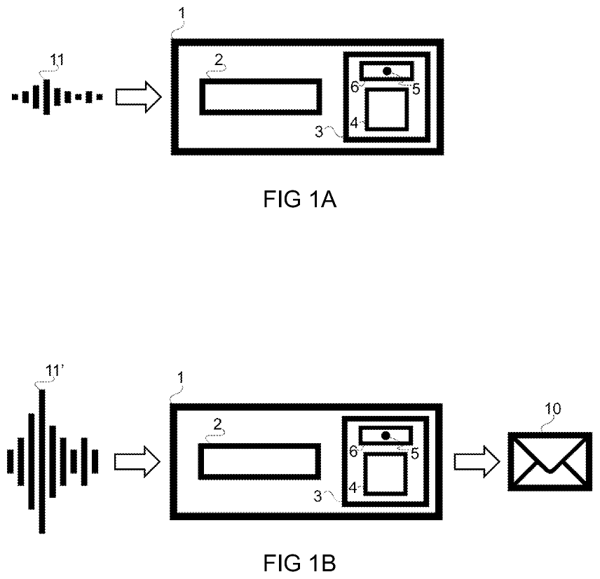

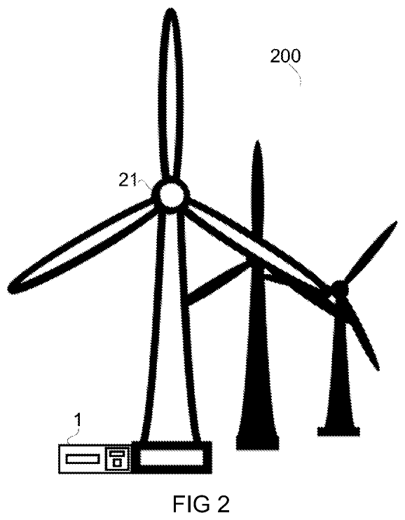

FIG. 1A and FIG. 1B schematically depict a simplified diagram of an embodiment of a device 1 configured to monitor a vibrating object, comprising a common housing holding an accelerometer 2 for sampling vibration signatures (11 and 11′) of the vibrating object, resulting in vibration samples, and a computing device 3 comprising a data processor 4 and a memory 6 having stored thereon a computer program product 5 for monitoring the vibrating object. Computer program product 5 comprises an input module to receive vibration samples, and an analysis module to analyze vibration samples to derive asset health scores, and a machine learning model to determine asset operating ranges, and an output module to output messages 10.

In this embodiment, device 1 consumes less current than 20 mA.

In this embodiment device 1 receives vibration signatures (11 and 11′) from a vibrating object. Accelerometer 2 samples the vibration signatures (11 and 11′) of the vibrating object. Computer program product 5 runs on data processor 4 and causes the computing device 3 to receive during a time interval, having an end time t1, the vibration samples from accelerometer 2, resulting in a time series vector array, and to analyze the vibration samples, the analyzing comprises deriving from the time series vector array a baseline asset health score and deriving from the time series vector array a time series asset health score, and to subject at least a part of the time series asset health score to the machine learning model for determining at least one asset operating range, and to receive a further vibration sample at a monitor time t2 wherein the monitor time t2 is subsequent to the end time t1, and to derive from the further vibration sample an asset health score, and to determine if the asset health score falls within an operating range determined by the machine learning model, resulting in a monitor result, and to output a message 10 depending on the monitor result.

As illustrated in FIG. 1A, the device 1 receives vibration signatures 11 from a vibrating object, resulting in a vibration sample that has a health score falling within an operating range determined by the machine learning model and as a result device 1 does not send a message 10.

As illustrated in FIG. 1B, the device 1 receives vibration signatures 11′ from a vibrating object, resulting in a vibration sample that has a health score not falling within an operating range determined by the machine learning model and as a result device 1 does send a message 10.

In a further embodiment when device 1 receives vibration signatures 11 from a vibrating object, resulting in a vibration sample that has a health score falling within an operating range determined by the machine learning model and as a result device 1 does send a message 10, for example a message 10 indicating “everything is fine”.

In a further embodiment, device 1 comprises a power source.

In a further embodiment, the power source of device 1 is selected from one or more batteries, PV cells with suitable capacitors, energy harvesting systems with suitable capacitor, and a combination thereof. Battery types to be used may be rechargeable lithium polymer (LiPo), lithium ion or alkaline.

In a further embodiment, the power source of device 1 has a minimum surge/peak current support of 750 mA.

In a further embodiment, device 1 optimizes power consumption by actively partitioning processing between analog, digital and RF domains. As a result, the device consumes very little current (typically less than 100 μA in standby mode and 5 mA in active mode). This embodiment of device 1 therefore can support a wide variety of power sources.

In a further embodiment, device 1 consumes less current than 150 μA in standby mode and less current 20 mA in active mode.

FIG. 2 schematically depicts an embodiment of monitoring example 200 wherein device 1 is monitoring a wind turbine 21. Device 1 receives vibrations samples of wind turbine 21 and is able to monitor the health or condition of wind turbine 21 by inferring the results from the data derived from the vibration samples. As a result, device 1 can detect faults in the mechanism of the wind turbine, predict when failures are likely to occur, and when maintenance should be scheduled.

In an embodiment device 1 has a connection to a remote messaging system to update a dashboard displaying the health or condition of the wind turbine, and/or to notify when a fault is detected and repair or maintenance is needed.

In a further embodiment of device 1 inference results of device 1 are stored on a non-transitory computer readable medium (such as a SSD or HDD).

In further embodiments device 1 is monitoring one selected from a vibrating pump, a vibrating compressor, a vibrating turbine, a vibrating vehicle, a vibrating satellite, a vibrating motor, a vibrating fan, a vibrating pipe, a vibrating construction part, a vibrating steel sheet, a vibrating cover, a vibrating surface of the earth, and a combination thereof

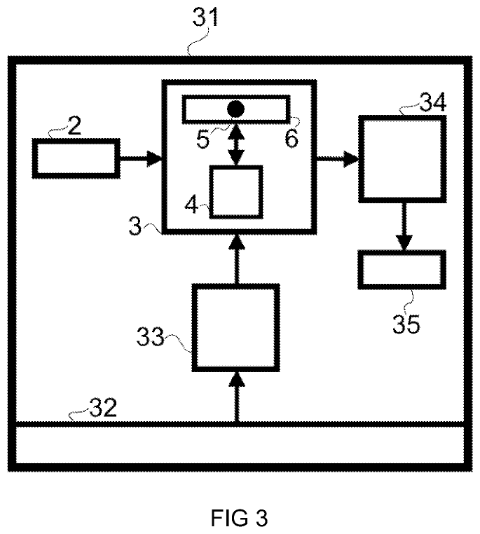

FIG. 3 schematically depicts a simplified diagram of an embodiment of a system 31 configured to monitor a vibrating object comprising a power source 32, a power management circuit 33 to control flow and direction of electrical power from power source 32, a computing device 3 comprising a data processor 4 and a memory 6 having stored thereon a computer program product 5 for monitoring the vibrating object, an accelerometer 2 for sampling vibration signatures of the vibrating object resulting in vibration samples, a RF module 34, and an antenna 35. Computer program product 5 comprises an input module to receive vibration samples, and an analysis module to analyze vibration samples to derive asset health scores, and a machine learning model to determine asset operating ranges, and an output module to output messages 10.

In this embodiment, system 31 consumes less current than 20 mA. When system 31 receives vibration signatures from a vibrating object, accelerometer 2 samples vibration signatures of the vibrating object, resulting in vibration samples. Computer program product 5 runs on data processor 4 and causes computing device 3 to receive during a time interval, having an end time t1, the vibration samples from the accelerometer 2, resulting in a time series vector array, and to analyze the vibration samples, the analyzing comprises deriving from the time series vector array a baseline asset health score and deriving from the time series vector array a time series asset health score, and to subject at least a part of the time series asset health score to the machine learning model for determining at least one asset operating range, and to receive a further vibration sample at a monitor time t2 wherein the monitor time t2 is subsequent to the end time t1, and to derive from the further vibration sample an asset health score, and to determine if the asset health score falls within an operating range determined by the machine learning model, resulting in a monitor result, and to output a message 10 to RF module 34 depending on the monitor result, and wherein RF module 34 uses antenna 35 to transmit message 10.

In a further embodiment, the power source of system 31 is selected from AC power using a DC adapter, one or more batteries, PV cells with suitable capacitors, energy harvesting systems with suitable capacitor, and a combination thereof. Battery types to be used may be rechargeable lithium polymer (LiPo), lithium ion or alkaline.

In a further embodiment, the power source of system 31 has a minimum surge/peak current support of 750 mA.

In a further embodiment, system 31 optimizes power consumption by actively partitioning processing between analog, digital and RF domains. As a result, the system consumes very little current (typically less than 100 μA in standby mode and 5 mA in active mode). This embodiment of system 31 therefore can support a wide variety of power sources.

In a further embodiment, system 31 consumes less current than 150 μA in standby mode and less current than 20 mA in active mode.

In a further embodiment, system 31 is fitted in a common housing.

In a further embodiment, system 31 is operationally coupled to a vibrating object.

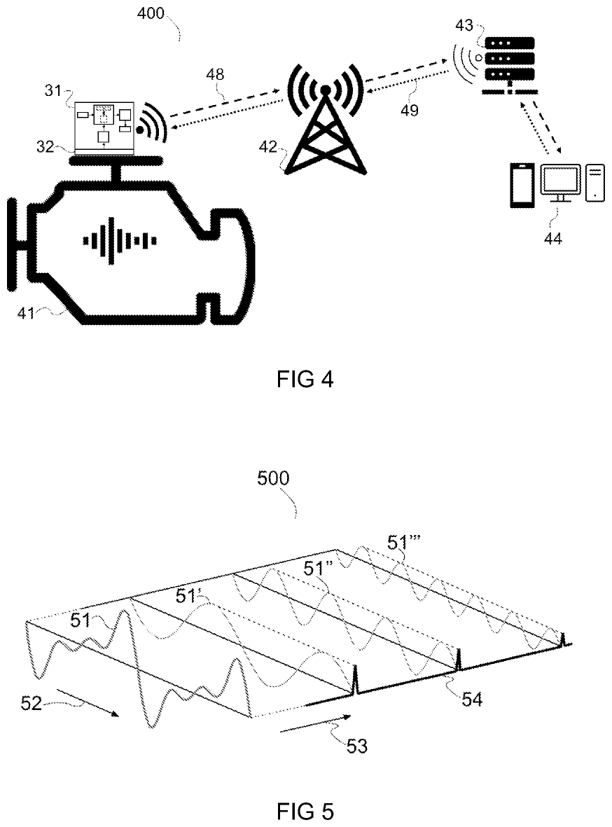

FIG. 4 schematically depicts an embodiment of a monitoring example 400 wherein system 31, with a battery 32, is monitoring an engine 41. System 31 has an uplink 48 to a cloud server 43, supported by a radio tower 42. Cloud server 43 processes messages 10 from system 31 received via uplink 48. Through various end-user computer devices (such as laptops, PCs and tablets), connected to cloud server 43, the messages 10 are distributed and presented as plain messages, graphs, statistics, KPIs, performance metrics, health metrics or a combinations thereof.

In a further embodiment system 31 can be configured and receive an update of computer program product 5 through downlink 49.

FIG. 5 schematically depicts a vibration spectrum analysis 500 of a complex vibration 51 over time 52 in three frequency bands (51′, 51″ and 51″′) and arrow 53 is referring to frequency. Frequency spectrum data is derived from the complex vibration 51 by using a Fast Fourier Transform (FFT) algorithm, resulting in a FFT array. The FFT algorithm is implemented as a software program which runs on the data processor 4 or 4′. The spectrum data is divided into three spectral energy bands which contain low, medium and high frequency components respectively. The bands (51′, 51″ and 51″′) are individually analyzed for changes and trends to determine anomalous behavior. The trend of the three vibration spectrum bands (51′, 51″ and 51″′) may indicate the possible root cause of the developing faults.

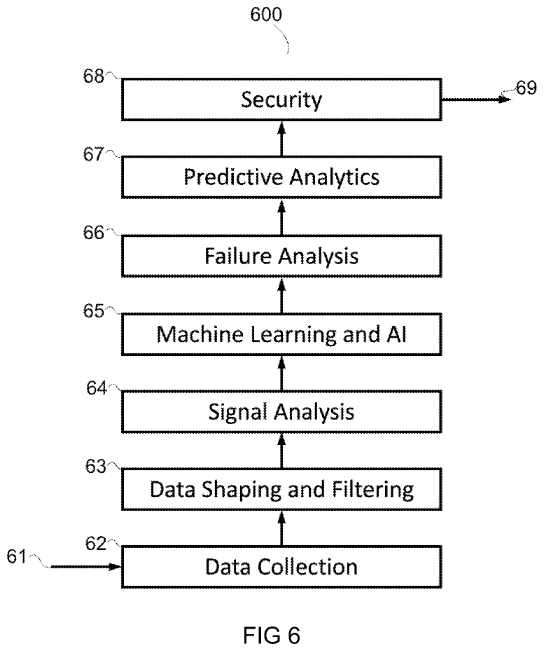

FIG. 6 depicts a simplified flow chart of an example firmware stack 600, wherein vibration signatures, collected from an object to be monitored (hereafter referred to as “asset”), are input 61 for Data Collection action 62. A microcontroller wakes up at pre-determined events (such as intervals triggered by a timer within the microcontroller or by an external timer/clock, or a sensor), an accelerometer 2 samples at least one vibration signature of an asset (such as embodiments 21 and 41). The at least one vibration signature for 3-axis (x, y and z) is collected. Timestamps are assigned to each sample. Samples are transferred to a microcontroller subsystem and stored in RAM memory 6. The first sample collected is stored in RAM memory 6 as the baseline value.

The 3-axis data of a sample is input for a Data Shaping and Filtering action 63 and measured against a pre-determined threshold to detect asset activity level. If the asset is on, then the data is filtered to remove noise floor and the filtered data is combined into a time series vector array resulting from vibration samples that correspond with a complex vibration 51. If the asset is off, the sample could be discarded.

The time series vector array is input for a Signal Analysis action 64 and a baseline asset health score (for example from 1 to 100) is derived from the time series vector array.

In addition, a time series asset health score (for examples with values from 1 to 100) is derived from the time series vector array using a Fast Fourier Transform (FFT) algorithm.

A time series vector array is converted into a spectrum array by extracting the individual frequency components of the time series data by using the FFT algorithm.

The spectrum array is further optimized by dividing the spectral energy into three frequency bands: low 51′, medium 51″ and high 51″′. The result of dividing the spectral energy are three compressed spectrum arrays, corresponding to the three bands (51′, 51″ and 51″′).

Three compressed spectrum arrays are individually analyzed for changes and trends to determine anomalous behavior.

A trend of the time series vector array indicates the overall health of the asset and the trend of the three frequency bands indicate the possible root cause of developing faults.

A time series asset health score is input for a Machine Learning and Al action 65 and:
I. analyzed for trends and patterns using previous baseline values, and
II. a FFT array is analyzed for spectral energy change by measuring frequency bin of highest magnitude and comparing with baseline values

In both analyses, baseline values are initially used to set the nominal operating level of the asset. During subsequent sampling periods, the measured values are used to determine the normal asset operating range of the asset and a ML model is trained dynamically using unsupervised learning, by:
1. Each data point after the baseline is set is used to further refine the range. If the data point is close to the baseline (for example +/−25%), then the moving average is calculated. Subsequent values are compared with the moving average.
2. When a sample falls outside the range, an anomaly alert is generated. A new asset operating range with the anomaly value as the baseline of the new range is created. Steps I. and II. are repeated until all normal asset operating ranges or operating modes are classified.
3. After every sample, the overall moving average is calculated using all observed values and is used for dynamic regression analysis.
4. A regression analysis output is projected 3 weeks into the future using slope extrapolation and is used for failure probability calculation.

A time series vector array is input for a Failure Analysis 66 and is used to detect overall vibration. Overall vibration values correspond to general condition of the asset. As the asset deteriorates, the overall vibration will increase.

In addition, a FFT array is input for a Failure Analysis action 66 and is used to detect root-cause factors. Change in spectral energy of low frequency spectrum corresponds to mechanical/structural issues with the asset and change in high frequency spectrum corresponds to bearing-related issues.

Time series trends and FFT trends are input for a Predictive Analytics action 67 and are combined to determine failure probability by comparing the present values, change trajectory and projected moving average values resulting from signal analysis.

The result of the failure analysis and predictive analyses is input for a Security action 68 and is converted into an encrypted message as output 69.

Although listed in a sequential order, these actions for monitoring an asset may in some instances be performed in parallel. Also, the various actions may be combined into fewer actions, divided into additional actions, and/or removed based upon the desired implementation.

For example, a machine learning is also described by these steps:
1. An asset health score (for example 0-100) derived from the first time series vector array forms a baseline asset health score.
2. A time series asset health score derived from a baseline asset health score is used to train a first ML model.
3. The first ML model is used to predict the asset health score into the future.
4. If the predicted asset health score is above a pre-determined threshold (>75), then an anomaly is generated and the probability of failure is calculated.
5. A second ML model for determining asset operating ranges, resulting from step 6 to 8.
6. The baseline asset health score (from step 1) is also used to create an asset operating range (for example: mode 0).
7. The time series asset health score (from step 2) is compared with the baseline asset health score and if it is close to the baseline (within 25%), then the asset is considered to still be in mode 0.
8. If the asset health score deviates from the baseline (>25%), then an additional asset operating range is created (for example: mode 1, 2, 3, . . . ) and this step is repeated for subsequent asset health scores.
9. Anomalies are generated when a new operating mode is created and when any outliers are detected.

In further examples a machine learning model uses a trend indicator, in particularly moving average, for trend analysis.

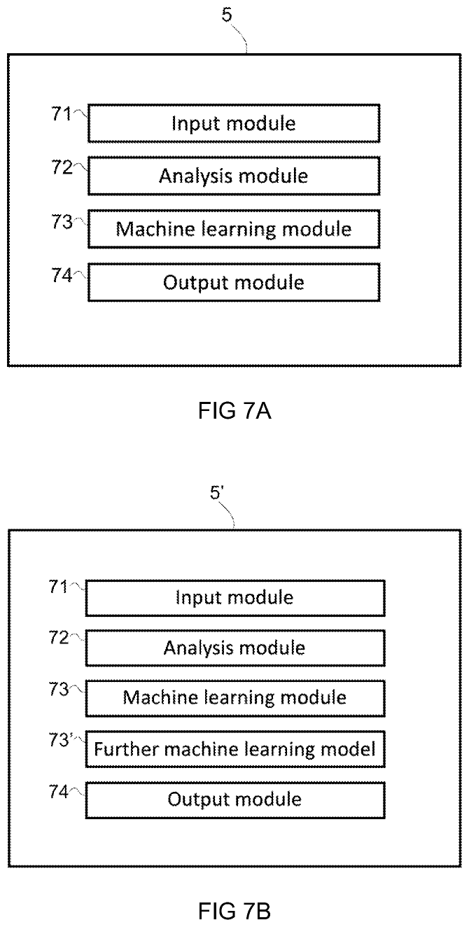

FIG. 7A and FIG. 7B depict a simplified block diagram of a computer program product 5 and 5′.

As illustrated in FIG. 7A an embodiment of computer program product 5 comprises:
an input module 71 to receive the vibration samples;
an analysis module 72 to analyze the vibration samples to derive asset health scores;
a machine learning model 73 to determine asset operating ranges, and
an output module 74 to output messages,
   wherein the computer program product 5 when running on the data processor 4 causes the computing device to:
receive during a time interval, having an end time t1, the vibration samples from the accelerometer 2, resulting in a time series vector array;
analyze the vibration samples comprising:
   deriving from the time series vector array a baseline asset health score, and
   deriving from the time series vector array a time series asset health score;
subject at least a part of the time series asset health score to the machine learning model 73 for determining at least one asset operating range;
receive a further vibration sample at a monitor time t2 wherein the monitor time t2 is subsequent to the end time t1;
derive from the further vibration sample an asset health score;
determine if the asset health score falls within an operating range determined by the machine learning model 73, resulting in a monitor result, and
output a message 10 depending on the monitor result.

As illustrated in FIG. 7B a further embodiment of computer program product 5′ furthermore comprises a further machine learning model 73′ to predict future asset health scores, and wherein the computer program product 5′ when running on the data processor 4 causes the computing device to:
subject at least a part of the time series asset health score to the further machine learning model 73′ for predicting a future asset health score at a future time t4 subsequent to the end time t1;
derive, at a predict time t3, the future asset health score from the further machine learning model 73′ wherein the predict time t3 is equal or subsequent to the end time t1 and wherein the predict time t3 is prior to the future time t4;
output a message 10 depending on a deviation of the future asset health score from the baseline asset health score.

It will also be clear that the above description and drawings are included to illustrate some embodiments of the current invention, and not to limit the scope of protection. Starting from this disclosure, many more embodiments will be evident to a skilled person. These embodiments are within the scope of protection and the essence of this invention and are obvious combinations of prior art techniques and the disclosure of this patent. The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A device configured to monitor a vibrating object, the device comprising a common housing holding:
an accelerometer for sampling vibration signatures of the vibrating object, resulting in vibration samples, and
a computing device comprising a data processor and a memory having stored thereon a computer program product for monitoring the vibrating object, the computer program product comprising:
an input module to receive the vibration samples;
an analysis module to analyze the vibration samples to derive asset health scores;
a machine learning model to determine asset operating ranges, and
an output module to output messages,
wherein the computer program product when running on the data processor causes the computing device to:
receive during a time interval, having an end time t1, the vibration samples from the accelerometer, resulting in a time series vector array;
analyze the vibration samples comprising:
deriving from the time series vector array a baseline asset health score, and
deriving from the time series vector array a time series asset health score;
subject at least a part of the time series asset health score to the machine learning model for determining at least one asset operating range;
receive a further vibration sample at a monitor time t2 wherein the monitor time t2 is subsequent to the end time t1;
derive from the further vibration sample an asset health score;
determine if the asset health score falls within an operating range determined by the machine learning model, resulting in a monitor result;
output a message depending on the monitor result, and
wherein the device consumes less current than 20 mA.

2. The device of claim 1, wherein furthermore the common housing holding a power source;

3. The device of claim 2, wherein the power source is selected from one or more batteries, PV cells with suitable capacitors, energy harvesting systems with suitable capacitor, and a combination thereof.

4. The device of claim 1, wherein the vibrating object is corresponding to one selected from a vibrating pump, a vibrating compressor, a vibrating turbine, a vibrating vehicle, a vibrating satellite, a vibrating motor, a vibrating fan, a vibrating pipe, a vibrating construction part, a vibrating steel sheet, a vibrating cover, a vibrating surface of the earth, and a combination thereof.

5. The device of claim 1, wherein furthermore the computer program product comprises a further machine learning model to predict future asset health scores, and wherein the computer program product when running on the data processor causes the computing device to:
subject at least a part of the time series asset health score to the further machine learning model for predicting a future asset health score at a future time t4 subsequent to the end time t1;
derive, at a predict time t3, the future asset health score from the further machine learning model wherein the predict time t3 is equal or subsequent to the end time t1 and wherein the predict time t3 is prior to the future time t4;
output a message to the RF module depending on a deviation of the future asset health score from the baseline asset health score.

6. A system configured to monitor a vibrating object, comprising:
a power source;
a power management circuit to control flow and direction of electrical power from the power source;
an accelerometer for sampling vibration signatures of the vibrating object, resulting in vibration samples;
a RF module;
an antenna, and
a computing device comprising a data processor and a memory having stored thereon a computer program product for monitoring the vibrating object, the computer program product comprising:
an input module to receive the vibration samples;
an analysis module to analyze the vibration samples to derive asset health scores;
a machine learning model to determine asset operating ranges, and
an output module to output messages,
wherein the computer program product when running on the data processor causes the computing device to:
receive during a time interval, having an end time t1, the vibration samples from the accelerometer, resulting in a time series vector array;
analyze the vibration samples comprising:
deriving from the time series vector array a baseline asset health score, and
deriving from the time series vector array a time series asset health score;
subject at least a part of the time series asset health score to the machine learning model for determining at least one asset operating range;
receive a further vibration sample at a monitor time t2 wherein the monitor time t2 is subsequent to the end time t1;
derive from the further vibration sample an asset health score;
determine if the asset health score falls within an operating range determined by the machine learning model, resulting in a monitor result;
output a message to the RF module depending on the monitor result, and
wherein the RF module uses the antenna to transmit the message, and
wherein the system consumes less current than 1 A.

7. The system of claim 6, wherein the power source is selected from AC power using a DC adapter, one or more batteries, PV cells with suitable capacitors, energy harvesting systems with suitable capacitor, and a combination thereof.

8. The system of claim 6, wherein the system is fitted in a common housing.

9. The system of claim 8, wherein the system is operationally coupled to the vibrating object.

10. The system of claim 6, wherein furthermore the computer program product comprises a further machine learning model to predict future asset health scores, and wherein the computer program product when running on the data processor causes the computing device to:
subject at least a part of the time series asset health score to the further machine learning model for predicting a future asset health score at a future time t4 subsequent to the end time t1;
derive, at a predict time t3, the future asset health score from the further machine learning model wherein the predict time t3 is equal or subsequent to the end time t1 and wherein the predict time t3 is prior to the future time t4;
output a message to the RF module depending on a deviation of the future asset health score from the baseline asset health score.

11. A method for monitoring a vibrating object with a system consuming less current than 150 μA in standby mode and consuming less current than 20 mA in active mode, comprising:
waking up the system at a pre-determined event from the standby mode to the active mode, and
while the system is in the active mode:
receiving during a time interval, having an end time t1, vibration samples corresponding to the vibrating object, resulting in a time series vector array;
analyzing the vibration samples comprising:
deriving from the time series vector array a baseline asset health score, and
deriving from the time series vector array a time series asset health score;
subjecting at least a part of the time series asset health score to a machine learning model for predicting a future asset health score at a future time t4 subsequent to the end time t1;
deriving, at a predict time t3, the future asset health score from the machine learning model wherein the predict time t3 is equal or subsequent to the end time t1, and wherein the predict time t3 is prior to the future time t4, and
outputting a message depending on a deviation of the future asset health score from the baseline asset health score.

12. The method of claim 11, wherein the pre-determined event is a pre-determined interval.

13. The method of claim 11, wherein the duration of the time interval is longer than the duration of a period between the predict time t3 and the future time t4.

14. The method of claim 11, comprising furthermore while the system is in the active mode:
subjecting at least a part of the time series asset health score to a further machine learning model for determining at least one asset operating range;
receiving a further vibration sample at a monitor time t2 wherein the monitor time t2 is subsequent to the end time t1;
deriving from the further vibration sample an asset health score;
determining if the asset health score falls within an operating range determined by the further machine learning model, resulting in a monitor result, and
outputting a message depending on the monitor result.

15. A non-transitory computer readable medium having stored thereon computer program instructions for monitoring a vibrating object that, when executed by a processor in a computing device consuming less current than 10 mA, configure the computing device to perform:
receiving during a time interval, having an end time t1, vibration samples corresponding to the vibrating object, resulting in a time series vector array;
analyzing the vibration samples comprising:
deriving from the time series vector array a baseline asset health score, and
deriving from the time series vector array a time series asset health score;
subjecting at least a part of the time series asset health score to a machine learning model for predicting a future asset health score at a future time t4 subsequent to the end time t1;
deriving, at a predict time t3, the future asset health score from the machine learning model wherein the predict time t3 is equal or subsequent to the end time t1 and wherein the predict time t3 is prior to the future time t4, and
outputting a message depending on a deviation of the future asset health score from the baseline asset health score.

16. The non-transitory computer readable medium having stored thereon computer program instructions for monitoring a vibrating object of claim 15 that furthermore configure the computing device to perform:
subjecting at least a part of the time series asset health score to a further machine learning model for determining at least one asset operating range;
receiving a further vibration sample at a monitor time t2 wherein the monitor time t2 is subsequent to the end time t1;
deriving from the further vibration sample an asset health score;
determining if the asset health score falls within an operating range determined by the further machine learning model, resulting in a monitor result, and
outputting a message depending on the monitor result.
